(19) United States
(12) Patent Application Publication
(10) Pub. No.: US 2010/0096056 A1
(43) Pub. Date: Apr. 22, 2010

(54) Re-inflatable inner tube

(76) Inventor: Joshua David Smith, Nashville, TN (US)

Correspondence Address: Joshua D. Smith, 314 Westfield Drive, Nashville, TN, 37221, US

(21) Appl. No.: 12/288,398

(22) Filed: Oct. 21, 2008

(51) Int. Cl. B60C 5/22

(52) U.S. Cl. 152/342.1

(57) ABSTRACT

A Re-Inflatable tire and inner tube system comprising of a primary flexible inflatable chamber and at least one secondary flexible inflatable chamber housed within the primary flexible inflatable chamber wherein all chambers share a single common inflation valve and wherein pressure is administered and controlled through the common valve to inflate one chamber at a time, independent and separate from all other chambers, while simultaneously releasing pressure from the chambers not being inflated.

### CROSS-REFERENCES TO RELATED APPLICATIONS

This application claims priority of U.S. co-pending Provisional Application No. 60/999,158, filed Oct. 16, 2007, entitled “Re-inflatable Bicycle Tire” the entirety of which is incorporated by reference herein.

### BACKGROUND OF THE INVENTION

The present invention relates generally to pneumatic inflation devices and methods for the re-inflation of a device when desired pressures are not maintained. More specifically, the present invention relates to a double inner tube with a single common valve, designed for use to apply pressure to separate inflation chambers independently from one another while simultaneously releasing pressure from chambers not intended to be inflated.

More specifically the invention relates to a tire inflation system designed for flat or leaking tires and inner tubes by manufacturing a secondary inflation compartment within the primary inflation compartment. In the event a puncture or leak occurs to the primary inflation compartment, the secondary inflation compartment can be inflated to completely fill the dead space inside the tire while expelling residual pressure from the primary compartment simultaneously through a common valve until proper working condition is resumed.

All bicycle enthusiasts have at one time or another experienced a flat tire due to a puncture or rupture of some sort. Once a flat is incurred, the affected wheel must be removed, tires removed and the inner tubes or tires replaced or patched. Though this process is not extremely difficult or overly time consuming, unless participating in a competition, it would be much quicker, convenient, and economical to be able to simply re-inflate the tire back to normal working condition.

Automobile drivers experience a similar situation when having a flat tire. In this situation, however, it can be much more time consuming and costly. One must locate and remove all the essential items from the car such as a jack, tire iron, etc. One must also remove the spare tire and possess the physical strength to remove the flat tire and replace it with the spare. It would be much quicker, convenient, and safer to have a car tire with a secondary inflatable compartment manufactured into the tire in an un-obstructed fashion to be inflated after a flat is incurred, in where the second chamber inflates to fill the dead space in the tire until proper pressure is achieved.

Re-inflatable inner tubes and tires have been designed and marketed before, however they have lacked the combination of several preferable features such as single valve operation, the secondary inflation chamber being housed within the primary inflation chamber allowing for the less rigid construction of the secondary chamber which reduces weight, and a mechanism to ensure proper re-inflation by releasing all undesired pressure from the primary inflation chamber which allows the secondary inflation chamber to fully occupy all the space in the primary chamber and maintain proper pressures.

The release of pressure from the primary chamber is important due to fluid displacement caused by inflation of an internal flexible chamber. As the internal flexible chamber is inflated, the space between the outer surface of the internal flexible chamber and the inner surface of the primary chamber becomes pressurized. When the present invention, not having the pressure release mechanism, is engaged to re-inflate a leaking inner tube or tire, the user would experience a temporarily inflated tube or tire which would then again eventually become flat. This happens because the pressure between the outer surface of the internal flexible chamber and the inner surface of the primary chamber becomes temporarily pressurized giving the false impression of a re-inflated tire, because the pressure will then continue to leak through the leaking primary chamber. By adding the pressure release mechanism, all space in the primary chamber is filled by an internal flexible chamber as it is inflated, therefore expelling all pressure from the primary chamber.

Previous dual inner tube designs incorporated multiple valves or a dual lumen inflatable chamber structure where each chamber is aside one another such as is described in U.S. Pat. No. 4,143,697, U.S. Pat. No. 5,385,191 and U.S. Pat. No. 5,746,850.

Valves have been designed to also inflate multiple chambers equally and simultaneously, described in U.S. Pat. No. 4,765,358, but a single valve has not been designed to inflate multiple chambers, one at a time and independent from each other, while simultaneously releasing pressure from chambers not being inflated.

### BRIEF SUMMARY OF THE INVENTION

Disclosed is a method and apparatus for re-inflating a device when the device will not maintain the desired pressure. The method comprises of a primary inflation chamber having within it one or additional inflation chambers in which pressure for all associated chambers is applied and controlled by the application of pressure through a single valve.

The valve is designed to introduce pressure to one inflatable compartment at a time while effectively sealing other compartments not intended to be inflated. The valve is designed to introduce pressure into compartments independently from all others. Additionally, the valve releases pressure from the unintended inflation chambers as the intended inflation chamber is inflated. This mechanism is important to ensure this invention properly re-inflates the device; as residual pressure will remain in the primary chamber. As the second or alternate chambers are inflated within the primary chamber, fluid is displaced causing an increase of pressure within the primary chamber. This pressure must escape to allow for the internal chambers to fill all dead space within the primary chamber.

The invention relates to a novel method and apparatus intended to inflate any inflation chamber by inflating one or more additional chambers which are housed within the primary chamber intended to be inflated. Additionally the invention is a novel method and apparatus intended to re-inflate a desired inflation chamber which is incapable of maintaining a desired pressure by inflating one or more additional chambers which are housed within the primary chamber intended to be inflated, while simultaneously releasing pressure from the primary chamber which would otherwise become trapped.

More specifically for the bicycle application, the primary inflation compartment resembles that of a standard bicycle inner tube, and the secondary inflation compartment resembles an additional inner tube housed within the primary inflation compartment, an annular tube within an annular tube. The, tube within a tube, design operates and is inflated by a single unique valve. This valve is designed to introduce pressure to one inflatable compartment at a time while effectively sealing the other compartment not intended to be inflated. The valve is designed to introduce pressure into either compartment. Additionally, during inflation of the secondary compartment housed within the primary compartment, fluid may be displaced resulting in temporary increased pressure within the primary compartment. Therefore, a pressure release mechanism is engineered into the primary inflation compartment via the inflation valve, so that accurate pressure resulting from the inflated secondary chamber may be determined.

Alternately the present invention may comprise of a bicycle tire functioning as the primary inflatable compartment with a secondary inflatable compartment manufactured into the primary inflatable compartment in an un-obstructed way. The secondary inflatable compartment may resemble a standard bicycle inner tube. Each inflation compartment directly interfaces with a single valve designed to introduce pressure into compartments independently from all others while the valve releases pressure from the unintended inflation chamber as the intended inflation chamber is inflated.

In the event a flat is incurred and the primary inflatable compartment is deflated, the secondary inflatable compartment may be inflated to fill in the dead space and release excess pressure of the primary inflatable compartment, resulting in a re-inflated tire.

It is necessary to release excess pressure from the primary/outer inflatable chamber as the secondary/inner inflatable chamber is inflated, via the pressure release mechanism, due to fluid displacement within the primary/outer inflatable chamber, to achieve immediate proper inflation.

### BRIEF DESCRIPTION OF THE SEVERAL VIEWS OF THE DRAWINGS

FIG. 1 is a cross-sectional illustration of a secondary annular tube within a primary annular tube, both meant for inflation, both attached to a singular valve meant to independently inflate each annular tube and release pressure from the chamber not being inflated;

FIG. 2 is a schematic illustration of a pressure regulating valve for regulating the desired pressure in a desired inflatable chamber, showing two positions for independent pressure regulating access to two inflation chambers;

FIG. 3 is a schematic illustration of an enlarged pressure regulating valve to further demonstrate the openings allowing for the distribution of pressure;

FIG. 4 is a schematic illustration of an alternate pressure regulating valve and the round disks used to attach and seal the independent inflation chambers and to separate the external openings which allow for pressure distribution;

FIG. 5 is an exploded schematic illustration of the alternate pressure regulating valve;

FIG. 6 is a schematic illustration of the alternate pressure regulating valve demonstrating two positions with the directional flow of pressure indicated by the arrows; and

FIG. 7 is a cross-sectional illustration of the fully inflated secondary annular tube within the primary annular tube, both attached to a singular valve meant to independently inflate each annular tube, demonstrating the release of pressure from the primary annular tube as the secondary annular tube is inflated as is shown by the arrows.

### DETAILED DESCRIPTION OD THE INVENTION

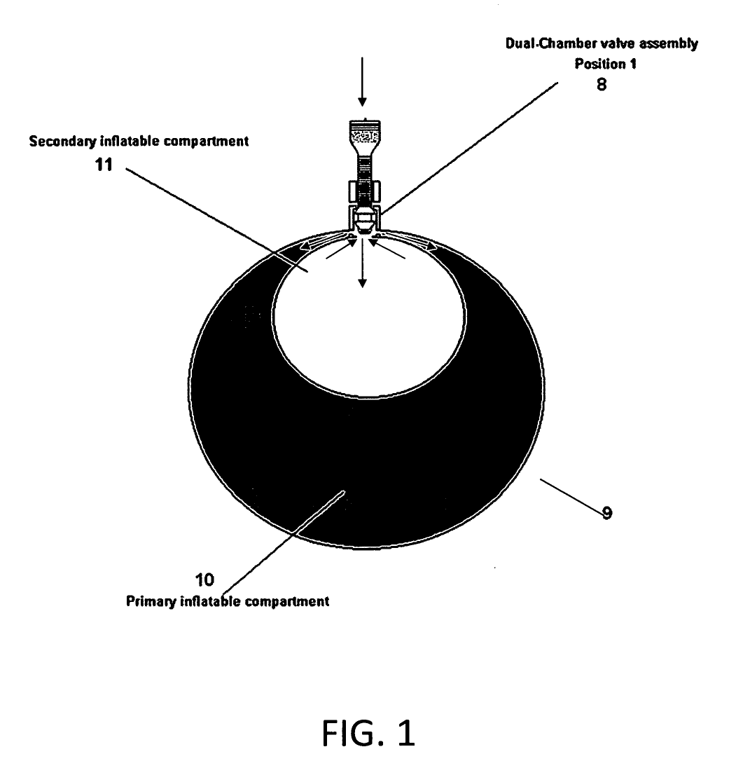

Referring generally now to FIG. 1, an inner tube 9 according to the present invention is illustrated. The inner tube 9 comprises of a primary inflatable annular tube 10 housing within it a secondary inflatable annular tube 11. Attached to the primary inflatable annular tube 10 and the secondary inflatable annular tube 11 is a single valve assembly 8 having dual operating positions, shown in the position 12 to inflate the primary inflatable annular tube 10.

As will be understood by those skilled in the art, the shown valve position 12 demonstrates open ports to both the primary inflatable annular tube 10 and the secondary inflatable annular tube 11 allowing pressure to initially enter both chambers. As pressure builds in the inner tube 9 and fluid travels the path of least resistance, the secondary inflatable annular tube 11 is collapsed under the pressure of the primary inflatable annular tube 10 effectively sealing off inflation access to the secondary inflatable annular tube 11 and maintaining an open inflation path to the primary inflatable annular tube 10. The arrows demonstrate the directional flow of the administered pressure.

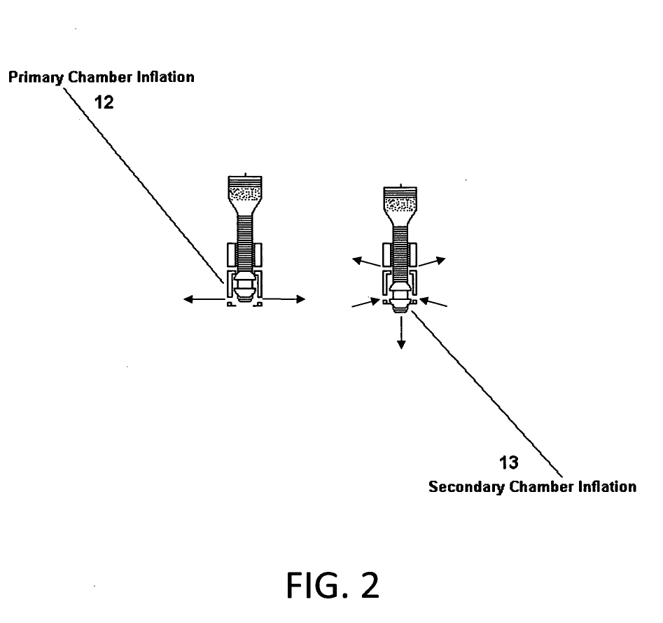

Turning next to FIG. 2, the valve assembly is shown in two operating positions with arrows showing the directional flow of pressure. Inflation of the primary inflatable annular tube 10 is demonstrated by the valve in a first operating position 12. Inflation of the secondary inflatable annular tube 11 is demonstrated by the valve in a second operating position 13.

As will be understood by those skilled in the art, the valve demonstrated in the second operating position 13, offers inflation access to the secondary inflatable annular tube 11 only, sealing it from the other inflation ports, while opening the other inflation ports to the atmosphere outside the inner tube 9. As the secondary inflatable annular tube 11 is inflated, pressure increases as the secondary inflatable annular tube 11 expands within the primary inflatable annular tube 10. This action drives all residual pressure from the primary inflatable annular tube 10 through its own inflation port 18 and out the pressure relief port on the valve housing 17.

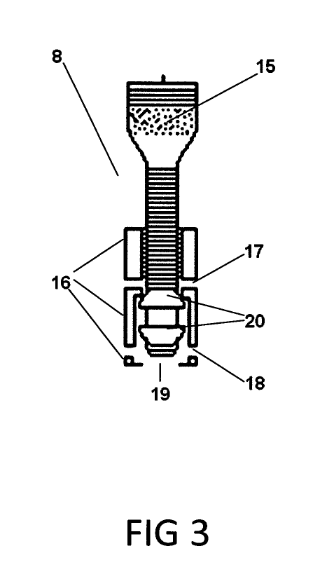

Moving to FIG. 3, the valve assembly is shown in detail demonstrating specific components. The inflation valve 15 is shown inserted into a valve housing 16. The assembly allows for the inflation valve 15 to change its position within the valve housing 16. Positioning of the inflation valve 15 determines the placement of the plug gaskets 20 within the valve housing 16 therefore determining which of the annular tubes receive the administered pressure.

Additionally FIG. 3 shows the valve assembly 8 in the first operating position 12 for inflation of the primary inflatable annular tube 10. The valve assembly in the first operating position 12 seals the pressure relief port 17, maintaining pressure within the inner tube 9. Also shown is the inflation port 18 to the primary inflatable annular tube 10 and the inflation port 19 to the secondary inflatable annular tube 11. The inflation port 18 doubles as a pressure relief port from the primary inflatable annular tube 10 when the valve assembly is in the second operating position 13 and pressure is increased within the secondary inflatable annular tube 11. The operating positions are determined by adjusting the inflation valve 15 which selects the appropriate port located in the valve housing 16.

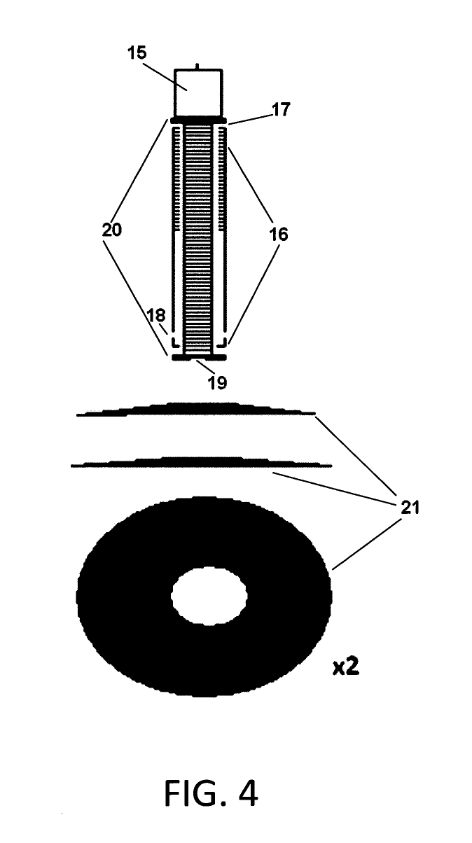

FIG. 4 shows an alternate valve assembly 8 detailing the inflation valve 15, valve housing 16, plug gaskets 20, pressure relief port 17, inflation port 18 to the primary inflatable annular tube 10, the inflation port 19 to the secondary inflatable annular tube 11, along with two disks 21.

As will be understood by those skilled in the art, the valve housing 16 must be connected to the primary inflatable annular tube 10 and the secondary inflatable annular tube 11 while separating the inflation port 18 from the inflation port 19, resulting in a finished product resembling the inner tube 9 of FIG. 1.

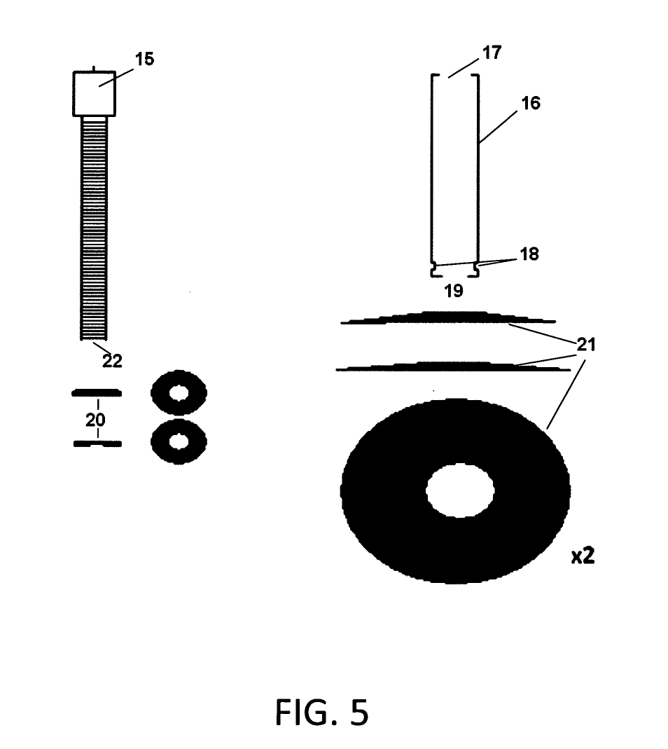

Turning next to FIG. 5, an exploded illustration of the valve assembly 8 is shown. The valve assembly comprises the inflation valve 15, valve housing 16, plug gaskets 20, pressure relief port 17, inflation port 18 to the primary inflatable annular tube 10, the inflation port 19 to the secondary inflatable annular tube 11, two disks 2, and the inflation valve pressure application port 22.

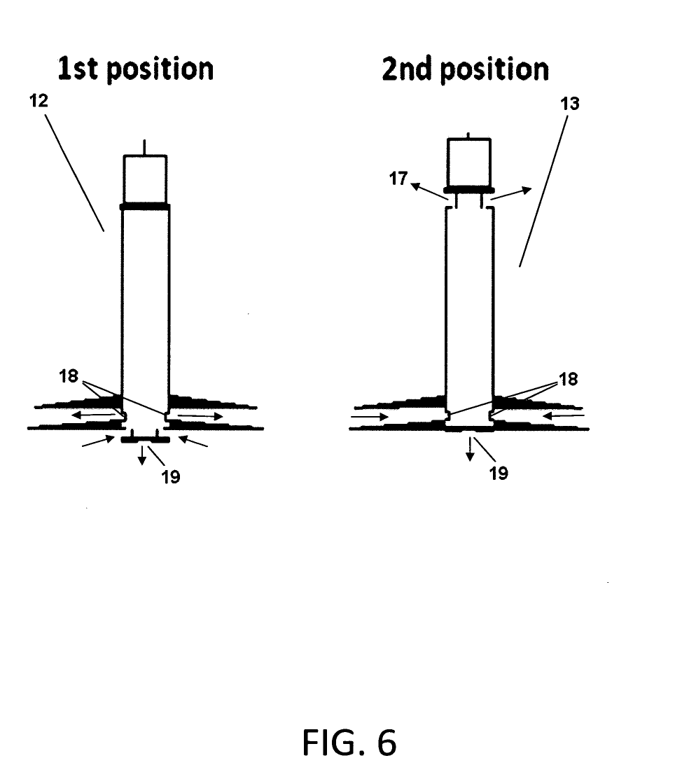

Moving to FIG. 6, an illustration shows the valve assembly 8 in two operating positions with arrows showing the directional flow of pressure. Inflation of the primary inflatable annular tube 10 is demonstrated by the valve in a first operating position 12. Inflation of the secondary inflatable annular tube 11 is demonstrated by the valve in a second operating position 13. The release of pressure from within the primary inflatable annular tube 10 is illustrated by the second operating position 13 and shown by the arrows.

As will be understood by those skilled in the art, the valve 8 demonstrated in the second operating position 13, offers inflation access to the secondary inflatable annular tube 11 only, sealing it from the other inflation ports, while opening the other inflation ports to the atmosphere outside the inner tube 9. As the secondary inflatable annular tube 11 is inflated, pressure increases as the secondary inflatable annular tube 11 expands within the primary inflatable annular tube 10. This action drives all residual pressure from the primary inflatable annular tube 10 through its own inflation port 18 and out the pressure relief port on the valve housing 17.

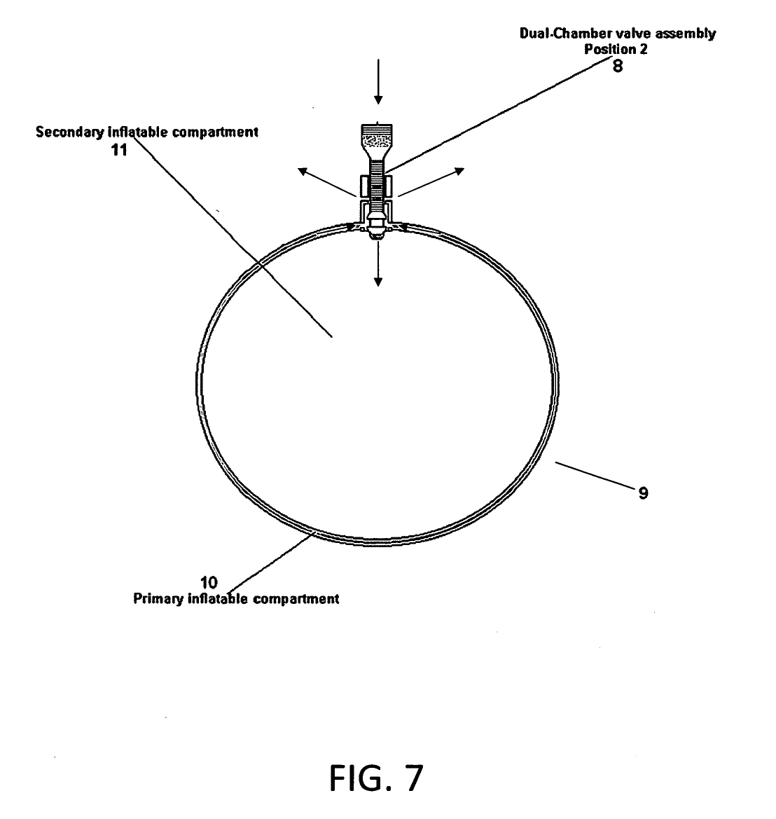

Turning next to FIG. 7, the cross-sectional illustration shows a fully inflated secondary inflatable annular tube 11 within the primary inflatable annular tube 10, connected by a single valve assembly 8 demonstrated in the second operating position 13 for the independent inflation of the secondary inflatable annular tube 11 causing residual pressure within the primary inflatable annular tube 10 to be expelled through the pressure administration port 18 of the primary inflatable annular tube 10 and out the pressure relief port 17 located on the valve housing 16.

Although the invention has been shown and described with respect to certain embodiments, it is obvious that equivalents and modifications will occur to others skilled in the art upon the reading and understanding of the specification. The present invention includes all such equivalents and modifications, and is limited only by the scope of the following claims.

What is claimed is:

1. An inner tube assembly (9) comprising
a primary outer flexible annular tube (10),
at least one secondary internal inflatable chamber (11) housed and sealed within the primary outer flexible annular tube (10), and
a single common inflation valve (8) having selective fluid communication with all associated flexible tubes and chambers;
wherein the valve (8) selectively supplies and controls the administration of pressure to each selected tube or chamber independently and separately from the other tube or chamber not selected; and
wherein pressure releases simultaneously to the atmosphere from the primary outer flexible annular tube (10) not selected, as pressure is supplied to the secondary internal inflatable chamber (11) which is selected.

2. The invention of claim 1 wherein pressure is administered through the external pressure administration port (15), located on the common valve (8), to the primary outer flexible annular tube (10),
wherein the pressure is delivered within the primary outer flexible annular tube (10), from the external pressure administration port (15), through a second internal port (18) located between the inner surface of the primary outer flexible annular tube (10) and the outer surface of the secondary internal inflatable chamber (11).

3. The invention of claim 1 wherein the secondary internal inflatable Chamber (11) is expanded sufficiently to expel pressure from between the inner surface of the primary outer flexible annular tube (10) and the outer surface of the secondary internal inflatable chambers (11) and eliminate space between the inner surface of the primary outer flexible annular tube (10) and the outer surface of the secondary internal inflatable chambers (11), and cause pressure to be applied to the inner surface of the primary outer flexible annular tube (10) by the surface of the internal inflatable chamber (11).

4. The invention of claim 1 wherein the secondary internal inflatable Chamber (11) is expanded sufficiently to expand the primary outer flexible annular tube (10) to the desired form and pressure.

5. The invention of claim 1 wherein the internal pressure reflected by the secondary internal inflatable chamber (11) is equal to the desired pressure of the primary outer flexible annular tube (10).

6. The invention of claim 1 wherein the pressure expelled from the primary outer flexible annular tube (10) is expelled through the single common inflation valve (8), first through a second internal port (18) located between the inner surface of the primary outer flexible annular tube (10) and the outer surface of the secondary internal inflatable chamber (11), and then through a pressure relief port (17), simultaneously during the process of inflating the secondary internal inflatable chamber (11).

7. The invention of claim 1 wherein the inflatable chambers are constructed of butyl rubber or latex rubber.

8. An adjustable pressure distribution valve (8) comprising:
a first primary external pressure administration port (15);
a valve housing (16) which encompasses part of the first primary external pressure administration port (15),
wherein the valve housing (16) has multiple secondary pressure administration ports (18)(19) and at least one pressure relief port (17),
wherein the first primary external pressure administration port (15) is adjusted to selectively communicate with one or more of the secondary pressure administration ports (18)(19) within the valve housing (16),
wherein the pressure relief port (17) is engaged by the selection of one of the secondary pressure administration ports (18)(19) within the valve housing (16),
wherein at least one of the secondary pressure administration ports (18) not selected, is in fluid communication with the pressure relief port (17).

9. The invention of claim 8 wherein the valve housing (16) is connected to multiple inflation chambers.

10. The invention of claim 9 wherein the chambers are separately and independently inflated.

11. The invention of claim 9 wherein at least one of the independently inflated Internal chambers (11) assists in the expelling of pressure from the primary external chamber (10) not being inflated.

12. The invention of claim 8 wherein the first primary external pressure administration port (15) is a Schrader, Woods or Presta Valve.

13. The invention of claim 8 wherein the first primary external pressure administration port (15) is textured and manually adjustable.

14. A method for administering pressure within a primary object (10) comprising:
applying pressure through a common valve (8) to one or more secondary flexible inflatable objects (11) housed within the primary object (10) and independent of the primary object (10);
wherein the inflation of the secondary flexible object (11) causes fluid displacement within the primary object (10) resulting in increased pressure between the outer surface of the secondary flexible object (11) and the inner surface of the primary object (10);
wherein the increased pressure between the outer surface of the secondary flexible object (11) and the inner surface of the primary object (10) is simultaneously expelled through a relief port (17) located on the common valve assembly (8) as the secondary flexible object (11) inflates and expands displacing fluid within the primary object (10),
wherein all of the pressure between the outer surface of the secondary flexible object (11) and the inner surface of the primary object (10) is expelled, eliminating all space between the outer surface of the secondary flexible object (11) and the inner surface of the primary object (10) resulting in pressure being applied to the inner surface of the primary object (10) by the outer surface of the secondary flexible inflatable object (11).

15. The method of claim 14 wherein the pressure inside the secondary flexible Object (11) reflect the same desired pressure of the primary object (10).

16. The method of claim 14 wherein the primary object (10) is an inner tube.

17. The method of claim 14 wherein the primary object (10) is a tire.

18. The method of claim 14 wherein the common valve (8) engages each inflatable object separately and independently from the others.

19. The method of claim 14 wherein the primary external pressure administration port (15) is a Schrader, Woods or Presta Valve.

20. The method of claim 16 wherein the inner tube is constructed of butyl rubber or latex rubber.
